(19) United States
(12) Patent Application Publication
(10) Pub. No.: US 2011/0175717 A1
(43) Pub. Date: Jul. 21, 2011

(54) PULSATING VEHICLE REVERSE ALERT LIGHT SYSTEMS

(76) Inventors: Richard E. Drong, Lemont, IL (US); Joanne P. Drong, Lemont, IL (US)

(21) Appl. No.: 12/938,301

(22) Filed: Nov. 2, 2010

Related U.S. Application Data
(60) Provisional application No. 61/296,367, filed on Jan. 19, 2010.

(51) Int. Cl. B60Q 1/22

(52) U.S. Cl. 340/463

(57) ABSTRACT

A pulsating vehicle reverse alert light system comprising an enclosed signal light bulb having a connection base wherein the connection base is installable to an open reverse light region/enclosure of a vehicle. The enclosed signal light bulb integrally comprises a first illumination element and a second illumination element. In a preferred embodiment, the first illumination element comprises a filament light emitter which may emit a steady indication light and the second illumination element may comprise a strobe light emitting diode comprising an intermittent alert signal. Both illumination elements are operable on varying frequencies and may cooperatively combine to create constructive interference. In use, the first illumination element and the second illumination element are electronically activated when the vehicle is being operated in a reverse condition providing increased visibility to surrounding motorists and pedestrians that the vehicle is backing up.

### CROSS-REFERENCE TO RELATED APPLICATION

The present application is related to and claims priority from prior provisional application Ser. No. 61/296,367, filed Jan. 19, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

1. Field of the Invention

The present invention relates generally to the field of alert lights for vehicles and more specifically relates to a pulsating reverse light with dual integral illumination sources to alert surrounding pedestrians and motorists that a vehicle is being operated in reverse.

2. Description of the Related Art

Vehicle alert lights are helpful in preventing automobile accidents by alerting motorists and pedestrians that a vehicle is moving in reverse. Traditionally referred to as stop lamps, a conventional brake and reverse light may comprise a continuous illumination light source emitting a continuous steady light. Generally, a solid red light is indicative that a car is braking and a solid white or yellow light above a brake light alerts surrounding persons that the vehicle is being driven in reverse. Brake and reverse lights are required to be installed in pairs to a rear portion of a motor vehicle to conform to a vast majority of state laws and local ordinances. However, often times a conventional brake/reverse lamp may be difficult to detect by other motorists in places such as congested shopping malls, busy streets, crowded parking lots, and apartment complexes. Furthermore, a traditional reverse light may be difficult to see during daytime hours on a sunny day when a motorist may be battling with a sun glare from the windshield or a walking pedestrian is temporarily blinded by the sun.

An example illustrating a common problem of conventional reverse lights occurs in crowded parking lots such as shopping mall parking lots. Often times, a small car may be parked between two SUVs, which are much larger, and therefore the small car may be almost completely hidden from view of an oncoming motorist driving down the parking lot aisle and looking left and right for an open parking spot. When the small car backs out of a space, the oncoming motorist may not see a continuous white light emitting from a conventional reverse light because the car is obstructed by the larger vehicles in the adjacent parking spots. As a result, the oncoming motorist may collide with the car backing out leading to an avoidable accident and necessitating expensive auto repairs and possible hospital visits. An effective solution is necessary.

Various attempts have been made to solve the above-mentioned problems such as those found in U.S. Pat. Nos. 4,403,210, 5,404,130, 5,847,513, 2004/0246740, 5,342,117, and 3,382,405. This prior art is representative of pulsating alert lights for vehicles. None of the above inventions and patents, taken either singularly or in combination, is seen to describe the invention as claimed.

Ideally, a pulsating alert light system should gain motorists and pedestrians immediate attention, operate reliably and be manufactured at a modest expense. Thus, a need exists for a reliable pulsating vehicle alert light system to alert nearby pedestrians and motorists that a vehicle is moving in reverse thus reducing the likelihood of accidents and to avoid the above-mentioned problems.

### BRIEF SUMMARY OF THE INVENTION

In view of the foregoing disadvantages inherent in the known vehicle alert light safety art, the present invention provides a novel increased visibility reverse light system. The general purpose of the present invention, which will be described subsequently in greater detail, is to provide an alert light for removable installment to a vehicle's existing reverse light region comprising two light emitting elements/means encased within a signal light bulb. The light emitting elements may be operable on different wave and color frequencies wherein a first illumination element may comprise a filament light emitter preferably emitting a solid white light and a second illumination element may comprise a strobe light emitting diode preferably emitting a powerful pulsating red (or other colored) light.

The light emitting elements of the present invention may be encased within an alert light shell comprising a transparent lens allowing for unobstructed passage of light. The pulsating reverse alert light may receive illumination power via the vehicle's battery (and electrical system) via a connection base attached to the bottom of the signal light bulb. When a user operates vehicle in a reverse condition (direction), power may be transmitted from the battery to a light power circuit located on a rear portion of the vehicle. When the vehicle is moving in reverse, the pulsating reverse alert light may provide increased detectability/visibility/warning means to surrounding motorists and pedestrians and thereby serving to reduce the probability an accident or a collision resulting. It should noted that two of the present invention may be used, one in each side rear socket of the car for ease of viewing from either side.

The present invention holds significant improvements and serves as an improved alert light system for vehicles. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and a method of use for the present invention, pulsating vehicle reverse alert light systems, constructed and operative according to the teachings of the present invention.

FIG. 1 shows a perspective view illustrating a pulsating reverse alert light for vehicles system in an in-use condition according to an embodiment of the present invention

FIG. 2 shows a magnified perspective view of the pulsating reverse alert light for vehicles system in an in-use condition from a side angle according to an embodiment of the present invention of FIG. 1.

FIG. 3 is a perspective view illustrating a pulsating reverse alert light comprising a strobe light emitting diode and a filament light bulb encased within a signal light bulb according to an embodiment of the present invention of FIG. 1.

FIG. 4 is a perspective view illustrating the power source of the pulsating reverse alert light according to an embodiment of the present invention of FIG. 1.

FIG. 5 is a front perspective view illustrating how nearby motorists and pedestrians may observe (be warned by) the pulsating reverse alert light in an in-use condition according to an embodiment of the present invention of FIG. 1.

FIG. 6 is a flowchart illustrating a method of use according to an embodiment of the present invention of FIGS. 1-5.

The various embodiments of the present invention will hereinafter be described in conjunction with the appended drawings, wherein like designations denote like elements.

### DETAILED DESCRIPTION

As discussed above, embodiments of the present invention relate to a pulsating reverse alert light for vehicles system and more particularly to an improved visibility reverse light for installation to an existing brake or reverse light enclosure/region which may serve to sufficiently alert surrounding motorists and pedestrians that the vehicle is in a reverse condition/direction thereby reducing the number of accidents and collisions.

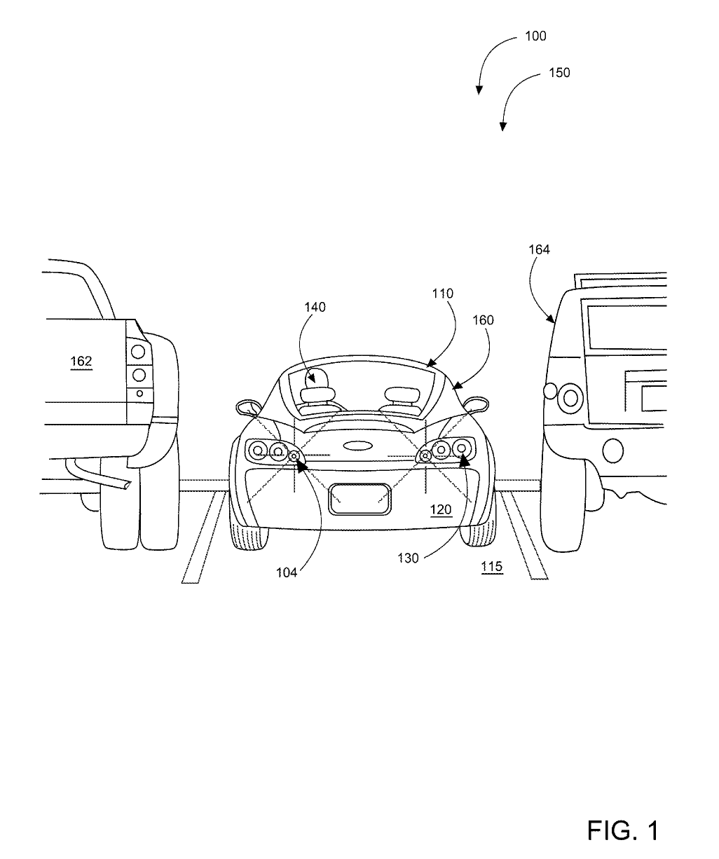

Referring to the drawings by numerals of reference there is shown in FIG. 1 pulsating reverse alert light for vehicles systems 100 in an in-use condition 150 installed to a rear portion of vehicle 110 according to one embodiment of the present invention. Pulsating reverse alert light for vehicles systems 100 may comprise alert light shell 200 wherein alert light shell 200 may comprise signal light bulb 210 having connection base 302. Signal light bulb 210 comprises filament light emitter 212 and strobe light emitting diode 215 within the present embodiment.

As seen in FIG. 1, vehicle 110 may comprise car 160 which may be of a coupe or two-door style automobile (or other) located in parking spot 115. Car 160 may be parked between truck 162 and SUV 164. When operated by user 140 in reverse condition 120, pulsating reverse alert light 104 may simultaneously emit both continuous light 242 from filament light emitter 212 and pulsating light 250 from strobe light emitting diode 215. Filament light emitter 212 and strobe light emitting diode 215 may be positioned within signal light bulb 210 in such a manner so that light emitting from both illumination elements projects outwardly through plastic lens 205 of enclosed alert light shell 200 and may be easily observed by nearby motorists 502 and pedestrians 504, thereby transmitting a visible warning means.

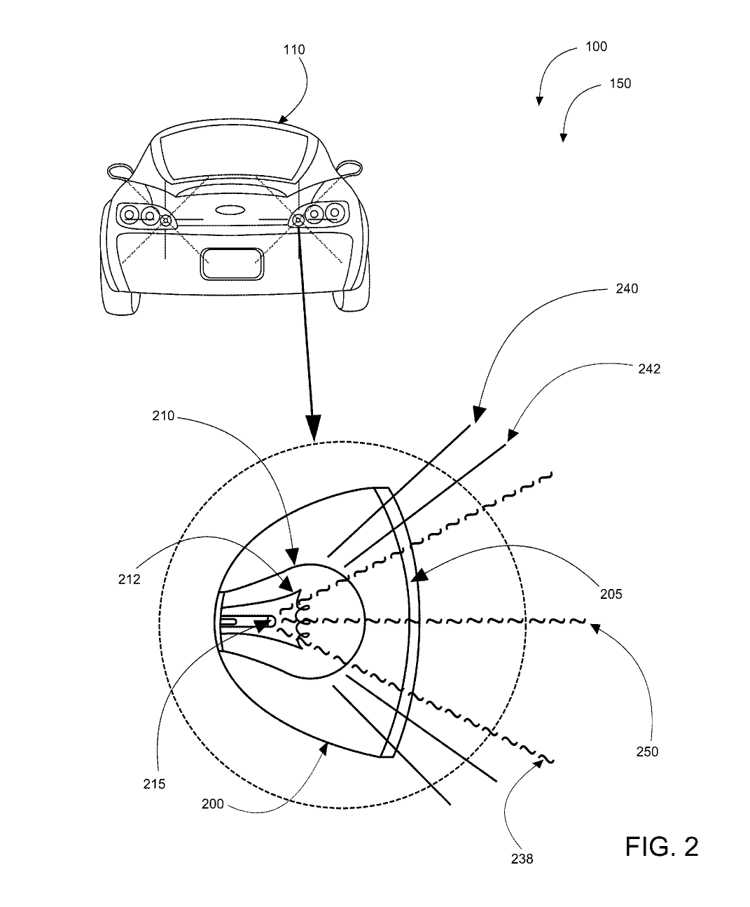

As alluded to in both FIGS. 1 and 2, pulsating reverse alert light 104 may be removably installed to vehicle 110 by removing an existing reverse light and connecting pulsating reverse alert light 104 to existing light power circuit 420. In such a manner, pulsating reverse alert light for vehicles systems 100 may be purchased by user 140 and installed to OEM vehicle 110 ‘after market’. It should be further noted that pulsating reverse alert light 104 may be pre-installed in vehicle 110 from the factory based on customer/manufacturer preference.

Referring more now to FIG. 2, a magnified side perspective view illustrating pulsating reverse alert light 104 according to an embodiment of the present invention of FIG. 1. As seen, alert light shell 200 integrally comprises signal light bulb 210 wherein signal light bulb 210 comprises filament light emitter 212 and strobe light emitting diode 215. In a preferred embodiment, filament light emitter 212 and strobe light emitting diode 215 are operable on different frequencies. Preferably, filament light emitter 212 may emit continuous light 240 and strobe light emitting diode 215 may emit pulsating light 250. In other embodiments of pulsating reverse alert light for vehicles systems 100, strobe light emitting diode 215 may comprise an adjustable frequency thereby allowing user 140 to control the intermittences of strobe light emitting diode 215.

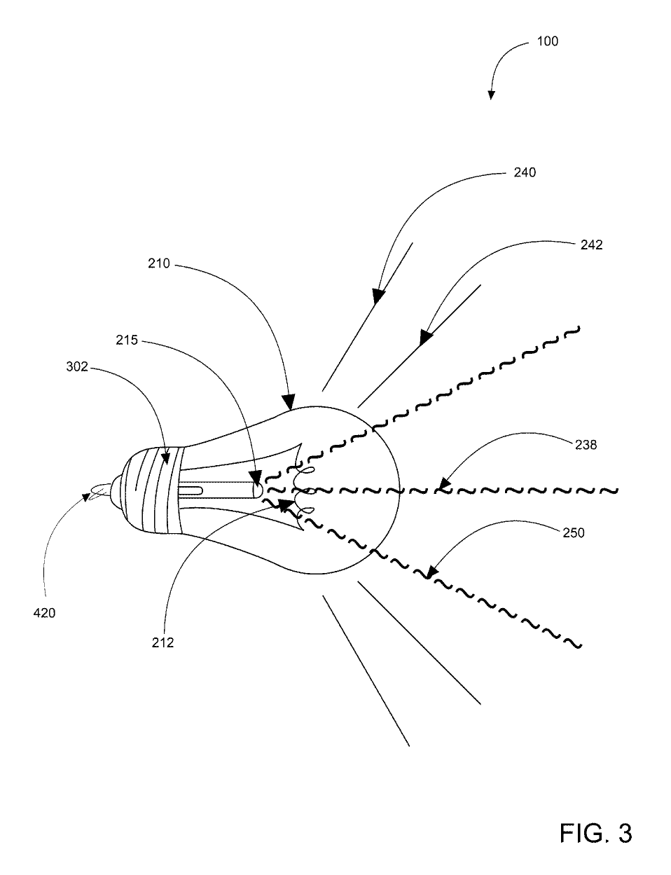

Referring now to FIG. 3, showing a perspective view of pulsating reverse alert light 104 comprising signal light bulb 210. Light bulb 210 may integrally comprise filament light emitter 212 and strobe light emitting diode 215. As can best be seen in FIG. 3, strobe light emitting diode (LED) 215 may be preferably positioned within center region of light bulb 210 and securably held in place by connection base 302. Strobe light emitting diode 215 may emit strong pulsating light 250 projecting outward through signal light bulb 210. In a preferred embodiment, strobe light emitting diode 215 may emit red light 238 that may blink intermittently. The variable frequency of strobe light emitting diode 215 may provide for additional detection of pulsating reverse alert light 104 while in an in-use condition 150. Signal light bulb 210 further comprises filament light emitter 212 that may emit continuous light 242 comprising red light 238 as seen in FIG. 3. In a preferred embodiment, filament light emitter 212 may emit white light 240. However, in alternative embodiments, filament light emitter 212 may emit other colored lights such as yellow and orange or other suitable like colors.

The illuminating duality of filament light emitter 212 and strobe light emitting diode 215 may emit frequency waves wherein the intensity of pulsating light 250 may be amplified by continuous light 242 projecting along a same/similar path. Temporal coherence is the measure of the average correlation between the values of a wave at any pair of times, separated by delay. The intermittent frequency of strobe light emitting diode 215 yields pulsating light 250 which may preferably increase the temporal coherence of the infused light emitting from signal light bulb 210 and thus may amplifying the illumination of the light source thereby increasing the likelihood of detectability by surrounding motorists 502 and pedestrian(s) 504.

Referring further to FIG. 3, alert light shell 200 may be constructed of durable, hard plastic. Further, alert light shell 200 may comprise plastic lens 205 which may be transparent thereby permitting unobstructed passage of light while protecting pulsating reverse alert light 104 from outdoor environmental conditions while installed to vehicle 110 in an in use condition 150. In this way the present invention is designed to be durable in-use promoting longevity in such a product for consumers.

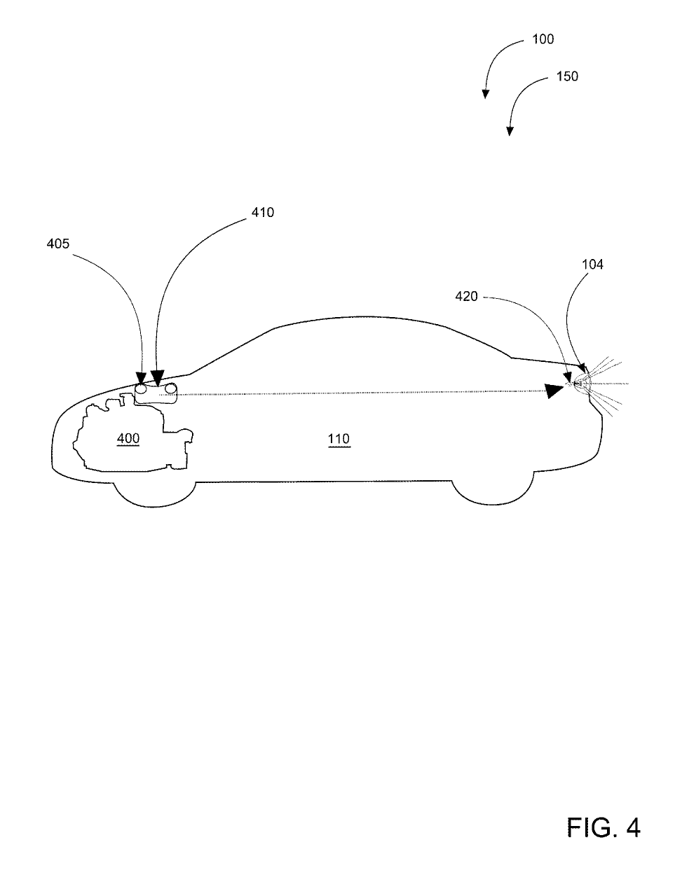

Referring now to FIG. 4, illustrating pulsating reverse alert light 104 being powered by (electrical system of) vehicle 110 using power source 410 generated by battery 405 of vehicle 110. In one embodiment of the present invention, pulsating reverse alert light 104 may receive power from a standard 12v power source. Power may be transferred from battery 405 to light power circuit 420 which may be in contact with connection base 302 of signal light bulb 210. In such a manner, when user 140 operates vehicle 110 in reverse condition 120, pulsating reverse alert light 104 may receive illumination power from power source 410 causing filament light emitter 212 and strobe light emitting diode 215 to emit light.

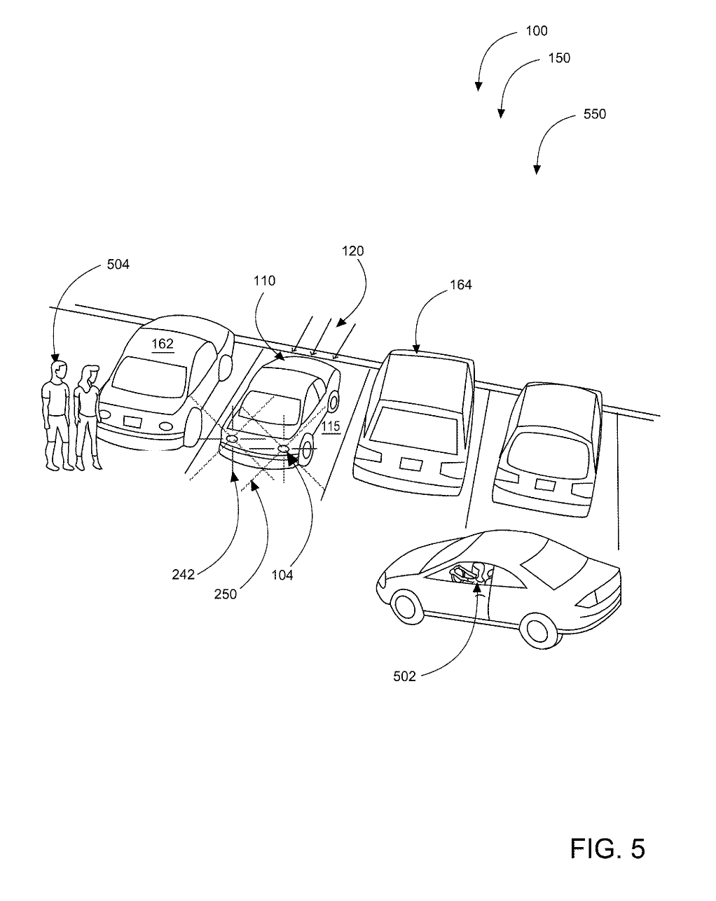

Referring now to FIG. 5, showing an embodiment of the present invention of FIG. 1 from an overview perspective. The combination of an intermittent red light 238 and a steady white light 240 emitting from the rear of vehicle 110 while in reverse condition 120 may serve to attract an increased amount of attention to vehicle 110. Eyes of motorists 502 and pedestrian 504 are naturally attracted to pulsating light 250, especially red light 238. For example, pedestrian 504 may be walking in a crowded parking lot during daytime amongst a row of parked cars. While walking past SUV 164, pedestrian 504 notices pulsating red light 250 reflecting off the side of vehicle 110 and discontinues walking behind vehicle 110. Pedestrians 504 often walk in blind spots of parked cars thus inhibiting user 140 from noticing pedestrian 504 suddenly passing rear of vehicle 110. Pedestrian 504 may further not have noticed white light 240 emitting from a conventional reverse light because of sun glare during daytime hours or due to being distracted by other cars or by children, phone call, etc. Thus, in these ways pulsating reverse alert light for vehicles systems 100 may serve to reduce accidents and injury to motorists 502, pedestrians 504, and the like due to the increased likelihood of attention between drawn to pulsating light 250 emitted by pulsating reverse alert light 104. It should noted that two of the present invention may be used, one in each side rear socket of vehicle 110 for ease of viewing from either side. In this way the present invention is clearly visible and thus safety is increased.

As further seen in FIG. 5, pulsating reverse alert light 104 in a similar way may be used to alert motorist 502 in oncoming car 160 that vehicle 110 is moving in reverse condition 120 as signified by activation of pulsating reverse alert light 104. In such an instance, motorist 502 may be distracted while looking for an available parking spot 115. If two larger automobiles such as truck 162 and SUV 164 are surrounding vehicle 110 comprising a smaller automobile, motorist 502 may have difficulty observing vehicle 110 while being obstructed. As a result, motorist 502 may not detect vehicle 110 backing up into traffic an accident may occur. However, motorist 502 will more likely observe pulsating light 250 emitting from pulsating reverse alert light 104 even while vehicle 110 is obstructed from view as a result of the increased wave frequency and combination of lights of both illumination elements and thereby serving to diminish the probability of an accident occurring.

Pulsating reverse alert light for vehicles systems 100 may be sold as kit 550 including the following parts: at least one alert light shell 200 preferably comprising plastic lens 205 and integrally comprising at least one signal light bulb 210; wherein signal light bulb 210 comprises at least one filament light emitter 212; at least one strobe light emitting diode 215; at least one connection base 302. Kit 550 may comprise a plurality of the devices and be offered with different color warning means, and at least one set of user instructions. Pulsating reverse alert light for vehicles systems 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, tunable frequencies, different frequencies, parts may be sold separately, etc., may be sufficient.

In alternative embodiments of the present invention, pulsating reverse alert light for vehicles systems 100 may be manufacturable in various shapes and sizes to fit vehicle 110 wherein vehicle 110 may include, but not limited to, car 160, truck 162, SUV 164, bus 166, or limousine 168 (or train or other land vehicle or optionally a non-land vehicle such as a boat). Further, pulsating reverse alert light for vehicles systems 100 may comprise filament light emitter 212 and strobe light emitting diode 215 which may comprise colors other than red light 238 and white light 240 based on customer preference. In other embodiments, the frequency of strobe light emitting diode 215 may vary thereby modifying the intermittency of pulsating light 250.

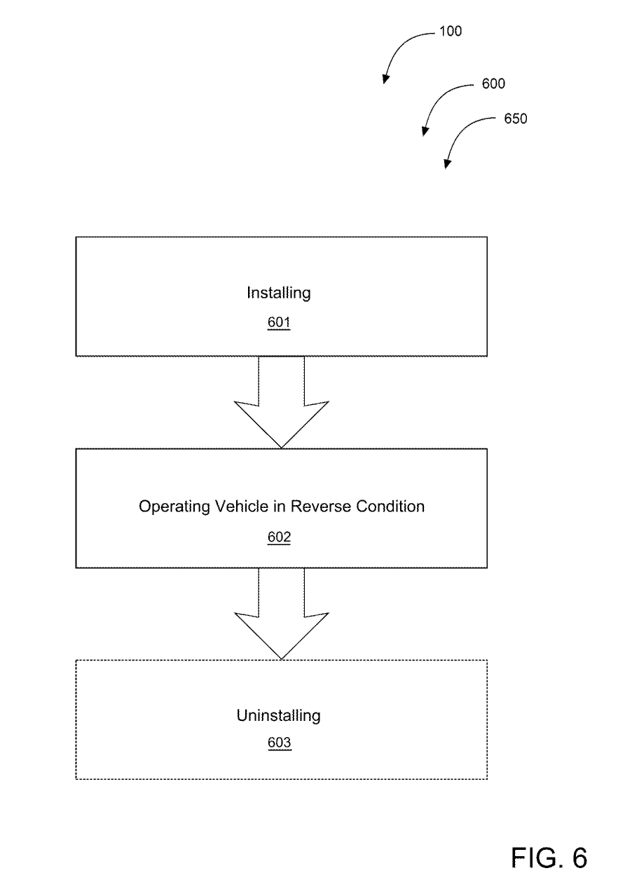

As seen in FIG. 6, method of use 600 may comprise the steps of; step one 601 installing pulsating reverse alert light 104 to reverse light region/enclosure/socket of vehicle 110; step two 602 operating vehicle 110 in reverse condition 120; and step three 603 uninstalling pulsating reverse alert light 104 from vehicle 110 (to replace as needed). It should be noted that step three 603 is an optional step and may not be implemented in all cases. Optional steps of method of use 600 are illustrated using dotted lines in FIG. 6 so as to distinguish them from the other steps.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A pulsating vehicle reverse alert light system comprising;
at least one alert light shell;
at least one plastic lens;
at least one enclosed signal light bulb having a connection base comprising;
at least one filament light emitter;
at least one strobe light emitting diode; and
at least one light power circuit to receive a power source;
wherein said filament light emitter and said strobe light emitting diode are operable on different wave frequencies;
wherein said enclosed signal light bulb receives power to illuminate said filament light emitter and said strobe light emitting diode from a battery powered source of said vehicle when said vehicle is in an active reversing condition; and
wherein said filament light emitter and said strobe light emitting diode cooperatively combine to create both a steady indication light and an intermittent alert signal thereby providing an improved means for indicating to nearby pedestrians and motorists that said vehicle is moving in a reverse direction.

2. The pulsating vehicle reverse alert light system of claim 1 wherein said at least one alert light shell encloses said at least one signal light bulb comprising a pulsating reverse alert light that is removably installable to an existing reverse light power circuit of said vehicle.

3. The pulsating vehicle reverse alert light system of claim 1 wherein said strobe light emitting diode comprises a semiconductor light source wherein said semiconductor light source emits light on a different wave frequency than said filament light emitter.

4. The pulsating vehicle reverse alert light system of claim 3 wherein said semiconductor light source emits light intermittently thereby providing temporal coherence of wave frequency via pulsating light.

5. The pulsating vehicle reverse alert light system of claim 3 wherein said strobe light emitting diode comprises a red light.

6. The pulsating vehicle reverse alert light system of claim 1 wherein said filament light emitter comprises white light emitting a static frequency thereby providing continuous light.

7. The pulsating vehicle reverse alert light system of claim 1 wherein the varying wave frequency of said strobe light emitting diode and said filament light emitter cooperatively combine to create constructive interference thereby providing increased projection of illumination of said pulsating reverse alert light.

8. The pulsating vehicle reverse alert light system of claim 1 wherein said pulsating reverse alert light receives power to said connection base of said signal light bulb from a battery of said vehicle.

9. The pulsating vehicle reverse alert light system of claim 1 wherein said pulsating reverse alert light is removably installable into a car.

10. The pulsating vehicle reverse alert light system of claim 1 wherein said pulsating reverse alert light is removably installable into a truck.

11. The pulsating vehicle reverse alert light system of claim 1 wherein said pulsating reverse alert light is removably installable into a SUV.

12. The pulsating vehicle reverse alert light system of claim 1 wherein said pulsating reverse alert light is removably installable into a bus.

13. The pulsating vehicle reverse alert light system of claim 1 wherein said pulsating reverse alert light is removably installable to a non-land vehicle.

14. The pulsating vehicle reverse alert light system of claim 1 wherein said alert light shell is manufacturable in various shapes and sizes to fit different size reverse light openings/sockets.

15. The pulsating vehicle reverse alert light system of claim 1 wherein said plastic lens comprises durable and transparent plastic thereby enabling unobstructed passage of light while providing increased protection to said pulsating reverse alert light.

16. The pulsating vehicle reverse alert light system of claim 1 wherein said alert light shell, said signal light bulb, said filament light emitter, and said strobe light emitting diode comprise a kit.

17. A pulsating vehicle reverse alert light system comprising:
at least one alert light shell comprising at least one transparent plastic lens, and at least one enclosed signal light bulb having a connection base and integrally comprising at least one filament light emitter and at least one strobe light emitting diode;
wherein a power source is supplied via a battery by said vehicle which provides illumination power to said signal light bulb;
wherein said filament light emitter emits a continuous white light and wherein said strobe light emitting diode emits a pulsating red light; and
wherein said filament light emitter and said strobe light emitting diode cooperatively combine to create both a steady indication light and an intermittent alert signal thereby providing an improved means for indicating to nearby pedestrians and motorists that said vehicle is moving in a reverse direction.

18. A method of using a pulsating vehicle reverse alert light system comprising the steps of:
installing a pulsating reverse alert light to a reverse light region/enclosure of a vehicle via an existing light power circuit of said vehicle;
operating said vehicle in a reverse condition; and
uninstalling said pulsating reverse alert light from said vehicle to replace said pulsating reverse alert light.
